(19) United States
(12) Patent Application Publication
(10) Pub. No.: US 2013/0171535 A1
(43) Pub. Date: Jul. 4, 2013

(54) SYSTEM FOR MEASURING PERFORMANCE OF SOLID OXIDE FUEL CELL

(71) Applicants: Sung Han Kim, Seoul (KR); Han Wool Ryu, Seoul (KR); Eon Soo Lee, Gyeongsangbuk-do (KR); Bon Seok Koo, Seoul (KR); Hong Ryul Lee, Gyunggi-do (KR)

(72) Inventors: Sung Han Kim, Seoul (KR); Han Wool Ryu, Seoul (KR); Eon Soo Lee, Gyeongsangbuk-do (KR); Bon Seok Koo, Seoul (KR); Hong Ryul Lee, Gyunggi-do (KR)

(73) Assignee: SAMSUNG ELECTRO-MECHANICS CO., LTD., Gyunggi-do (KR)

(21) Appl. No.: 13/479,050

(22) Filed: May 23, 2012

(30) Foreign Application Priority Data
Dec. 29, 2011 (KR) 1020110146294

(51) Int. Cl. H01M 8/04; H01M 8/10

(52) U.S. Cl. 429/431; 429/432

(57) ABSTRACT

Disclosed herein is a system for measuring performance of a solid oxide fuel cell, including: a heating furnace wrapping the solid oxide fuel cell, the heating furnace having a first opening part through which one lateral surface in a length direction of the solid oxide fuel cell outwardly protrudes and a fuel supply hole formed in one surface thereof; a first fuel storage unit; a second fuel storage unit; a first fuel supply control unit; a second fuel supply control unit; an electronic load measuring current or voltage outputted from the solid oxide fuel cell; and a control unit controlling the supply of fuel by using the first fuel supply control unit and the second fuel supply control unit, and controlling the measurement of current or voltage by using the electronic load.

### CROSS REFERENCE TO RELATED APPLICATION

This application claims the benefit of Korean Patent Application No. 10-2011-0146294, filed on Dec. 29, 2011, entitled “System for Measuring Solid Oxide Fuel Cell Performance”, which is hereby incorporated by reference in its entirety into this application.

### BACKGROUND OF THE INVENTION

1. Technical Field

The present invention relates to a system for measuring performance of a solid oxide fuel cell.

2. Description of the Related Art

Oil currently and widely used as an energy source has exhaustible reserves, and the oil is gradually running out as time goes by, and thus, energy problems have become national and global issues. For this reason, a fuel cell that can generate energy, such as electricity or the like, from oil, LNG, LPG fuels as well as alternative energy sources such as hydrogen and the like have increased interest.

Of various types of fuel cells that directly convert chemical energy of fuel into electric energy by an electric chemical reaction, a solid oxide fuel cell (SOFC) has high theoretical efficiency and require no various fuel reformers at the time of use thereof Hence, researches for commercializing the solid oxide fuel cell (SOFC) for home use or industrial use have actively progressed by centering on gas companies and electric power companies.

The operation of this solid oxide fuel cell (SOFC) and evaluation on performance thereof are carried out at a high temperature of about 800° C. In a case of a flat type solid oxide fuel cell, the performance evaluation method therefor has been developed by using a jig and a sealing agent

Meanwhile, in the prior art, a system for evaluating performance of a flat type solid oxide fuel cell is disclosed in US Patent Laid-Open Publication NO. 2005-0263393.

However, in a case of a cylindrical shape solid oxide fuel cell, the system for evaluating performance disclosed in the prior art can neither be employed nor be easily conducted.

### SUMMARY OF THE INVENTION

The present invention has been made in an effort to provide a system for measuring performance of a solid oxide fuel cell, and capable of easily measuring performance of a cylindrical shape solid oxide fuel cell.

The present invention has been also made in an effort to provide a system for measuring performance of a solid oxide fuel cell, requiring no sealing work for preventing two kinds of fuel from being mixed.

According to a preferred embodiment of the present invention, there is provided a system for measuring performance of a solid oxide fuel cell, including: a heating furnace wrapping the solid oxide fuel cell, the heating furnace having a first opening part through which one lateral surface in a length direction of the solid oxide fuel cell outwardly protrudes and a fuel supply hole formed in one surface thereof; a first fuel storage unit storing a first fuel supplied to the fuel supply hole; a second fuel storage unit storing a second fuel supplied into the solid oxide fuel cell; a first fuel supply control unit disposed between the first fuel storage unit and the fuel supply hole to control a supply amount of the first fuel; a second fuel supply control unit disposed between the second fuel storage unit and the solid oxide fuel cell to control a supply amount of the second fuel; an electronic load measuring current or voltage outputted from the solid oxide fuel cell; and a control unit controlling the supply of fuel to the fuel supply hole and the solid oxide fuel cell from the first fuel storage unit and the second fuel storage unit by using the first fuel supply control unit and the second fuel supply control unit, and controlling the measurement of current or voltage outputted from the solid oxide fuel cell by using the electronic load.

The system may further include a manifold having one end inserted into the solid oxide fuel cell through one lateral surface of the solid oxide fuel cell and the other end connected to the second fuel supply control unit, wherein one lateral surface of the solid oxide fuel cell may be opened and the other lateral surface of the solid oxide fuel cell may be closed.

The system may further include a connecting unit connecting the second fuel supply control unit to the other end of the manifold.

The system may further include: a third fuel storage unit storing a third fuel supplied into the solid oxide fuel cell; a third fuel supply control unit disposed between the third fuel storage unit and the solid oxide fuel cell to control a supply amount of the third fuel; and a connecting unit connecting the third fuel supply control unit to the other end of the manifold.

The third fuel may be nitrogen (N₂).

The system may further include a manifold having one end connected to one lateral surface of the solid oxide fuel cell and the other end connected to the second fuel supply control unit, wherein one lateral surface and the other lateral surface of the solid oxide fuel cell may be opened, and the heating furnace may further include a second opening part through which the other lateral surface of the solid oxide fuel cell outwardly protrudes.

The system may further include a connecting unit connecting the second fuel supply control unit to the other end of the manifold.

The system may further include a connecting member coupling one lateral surface of the solid oxide fuel cell and one end of the manifold with each other.

The system may further include an exhaust pipe disposed adjacently to the other lateral surface of the solid oxide fuel cell.

The system may further include: a third fuel storage unit storing a third fuel supplied into the solid oxide fuel cell; a third fuel supply control unit disposed between the third fuel storage unit and the solid oxide fuel cell to control a supply amount of the third fuel; and a connecting unit connecting the third fuel supply control unit to the other end of the manifold.

The third fuel may be nitrogen (N₂).

The first fuel and the second fuel may be oxygen (O₂) and hydrogen (H₂), respectively.

The system may further include a display unit displaying current or voltage measured by the electronic load, wherein the control unit may receive the current or voltage measured by the electronic load to transmit the received current or voltage to the display unit.

The system may further include a temperature sensor disposed on an inner wall of the heating furnace to measure an air temperature inside the heating furnace, wherein the control unit may control the driving of the heating furnace depending on the air temperature inside the heating furnace, which is measured by the temperature sensor.

### BRIEF DESCRIPTION OF THE DRAWINGS

FIG. 1 is a block diagram showing a structure of a system for measuring performance of a solid oxide fuel cell according to a preferred embodiment of the present invention;

FIG. 2 is a perspective view showing a structure of a heating furnace in the system for measuring performance of a solid oxide fuel cell according to the preferred embodiment of the present invention;

FIG. 3 is a block diagram showing a structure of a system for measuring performance of a solid oxide fuel cell according to another preferred embodiment of the present invention; and

FIG. 4 is a plane view showing a structure of a heating furnace in the system for measuring performance of a solid oxide fuel cell according to another preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that identical reference numerals designate identical components even though components are shown in different drawings. Further, in describing the present invention, a detailed description of related known functions or configurations will be omitted so as not to obscure the gist of the present invention. Terms used in the specification, ‘first’, ‘second’, etc., can be used to describe various components, but the components are not to be construed as being limited to the terms.

Hereinafter, preferred embodiments of the present invention will be described in detail with reference to the accompanying drawings.

### First Preferred Embodiment 1

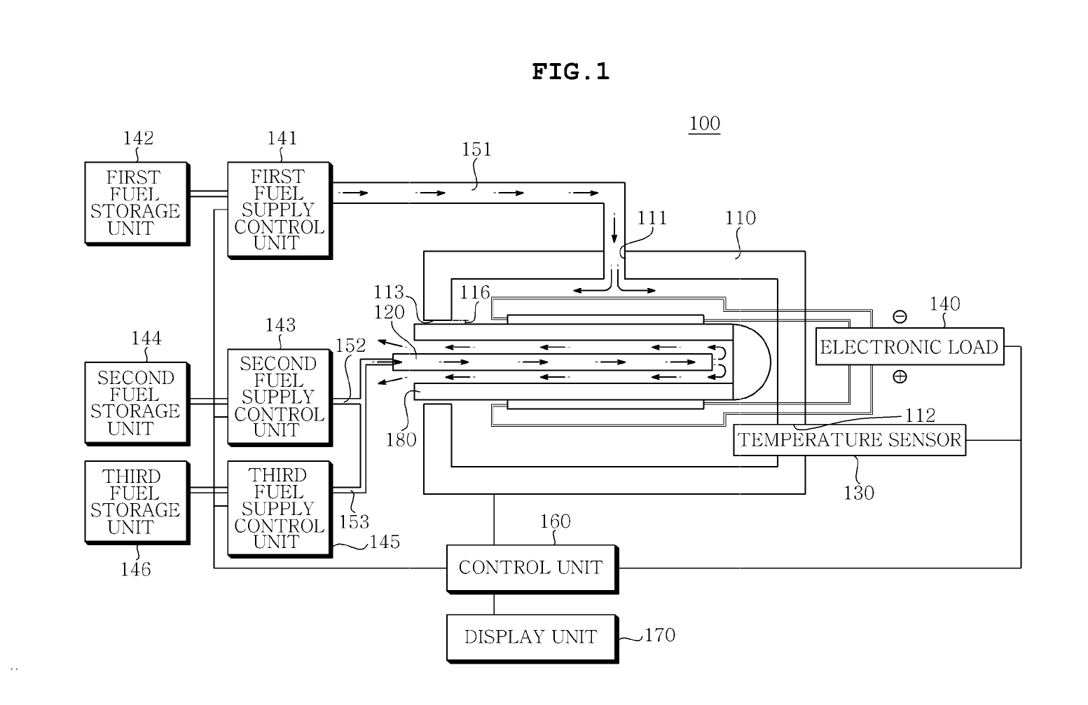

FIG. 1 is a block diagram showing a structure of a system for measuring performance of a solid oxide fuel cell according to a preferred embodiment of the present invention.

Referring to FIG. 1, a system 100 for measuring performance of a solid oxide fuel cell according to the present preferred embodiment include a heating furnace 110, a manifold 120, a first fuel storage unit 142, a second fuel storage unit 144, an electronic load 140, and a control unit 160.

In the present preferred embodiment, the heating furnace 110 may wrap a solid oxide fuel cell 180, and may have a first opening part 113 outwardly protruding a lateral surface in a length direction of the solid oxide fuel cell 180 therethrough.

Also, the heating furnace 110 may have a fuel supply hole 111 formed in one surface thereof.

Here, the length direction means a direction parallel with the moving direction of fuel inside the solid oxide fuel cell 180. In other words, the length direction means a direction parallel with an arrow direction inside the solid oxide fuel cell 180, as shown in FIG. 1.

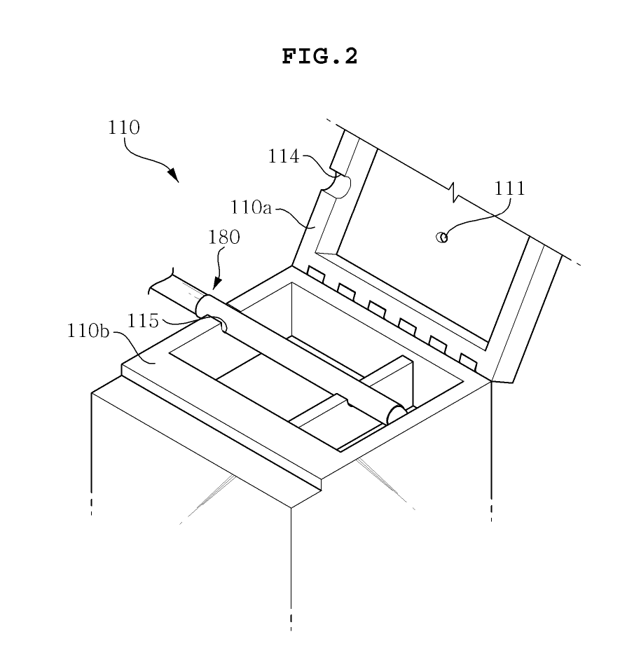

In addition, a structure of the heating furnace 110 according to the present preferred embodiment may be divided into a body part 110b and a cover part 111a, as shown in FIG. 2, but is not particularly limited thereto.

For example, the cover part 110a is opened, and then, one lateral surface of the solid oxide fuel cell 180 is disposed such that it protrudes outwardly, as shown in FIGS. 1 and 2. Then, the cover part 110a is closed, so that the heating furnace 110 wraps the solid oxide fuel cell 180. Here, grooves 115 and 114 corresponding to each other are formed in the body part 110b and the cover part 110a, respectively, as shown in FIG. 2. As such, one side of the solid oxide fuel cell 180 may protrude outwardly through the grooves 115 and 114.

In other words, the first opening part 113 of the heating furnace 110 may consist of a pair of grooves 115 and 114 corresponding to each other and formed in the body part 110b and the cover part 110a, but is not particularly limited thereto.

In addition, a gap 116 may be formed between the first opening part 113 and the solid oxide fuel cell 180 passing through the first opening part 113, as shown in FIG. 1. In the present preferred embodiment, a sealing work does not need to be performed on the gap 116.

In general, when hydrogen and oxygen respectively supplied to an anode and a cathode of the fuel cell are mixed with each other at a high temperature, explosion or the like may occur. Therefore, the performance evaluating apparatus of the prior art required a sealing work for preventing hydrogen and oxygen from being mixed.

However, in the present preferred embodiment, as described above, one lateral surface, that is, an opened side of the solid oxide fuel cell 180 protrudes out of the heating furnace 110 through the first opening part 113 of the heating furnace 110. Hence, hydrogen (H₂), which is a second fuel, supplied into the solid oxide fuel cell 180 moves in the arrow direction, as shown in FIG. 1, and then is exhausted of the heating furnace 110.

Therefore, even though the gap between the first opening part 113 and the solid oxide fuel cell 180 is not sealed, air as a first fuel supplied into the heating furnace 110 and hydrogen as a second fuel supplied into the solid oxide fuel cell 180 are not mixed with each other.

In general, the heating furnace 110 may be made of a high-temperature adiabatic material in order to achieve the configuration to keep a predetermined level of temperature, but is not particularly limited thereto.

In addition, heating lines may be buried in the high-temperature adiabatic material, and the air temperature inside the heating furnace 110 may be increased as the heating lines are heated.

Here, the control unit 160 may control the setting of the target temperature with respect to the air temperature, and also may control the temperature rise rate.

In addition, a fuel supply hole 111 may be formed in one surface of the heating furnace 110 of the system 100 according to the present preferred embodiment. The fuel supply hole 111 is formed in a surface parallel with the solid oxide fuel cell 180. However, this is for merely illustrating one preferred embodiment, but the present preferred embodiment is not particularly limited thereto.

In addition, in the present preferred embodiment, as shown in FIG. 1, the solid oxide fuel cell 180 may be in a cylindrical shape, of which one lateral surface in the length direction is opened and the other surface in the length direction is closed. However, this shape is for merely illustrating one preferred embodiment, but the present preferred embodiment is not particularly limited thereto.

In the present preferred embodiment, the manifold 120 may be inserted into the solid oxide fuel cell 180, as shown in FIG. 1.

The manifold 120 may have a tube shaped configuration for supplying fuel into the solid oxide fuel cell 180, and deeply inserted inside the solid oxide fuel cell 180, as shown in FIG. 1. In the present preferred embodiment, the manifold 120 may be made of metal, ceramics, or the like, but is not particularly limited thereto.

The first fuel storage unit 142 has a configuration for storing the first fuel supplied to the fuel supply hole 111 of the heating furnace 110. Here, the first fuel may be oxygen (O₂), but is not particularly limited thereto. The first fuel may be also normal air having a high oxygen (O₂) content.

In addition, the present preferred embodiment may further include a first fuel supply pipe 151, such as a connecting unit connecting the first fuel storage unit 142 to the fuel supply hole 111.

In addition, the present invention may further include a first fuel supply control unit 141 for controlling the amount of the first fuel supplied from the first fuel storage unit 142 to the first fuel supply pipe 151.

Here, the control unit 160 may control the amount of the first fuel supplied from the first fuel storage unit 142 to the first fuel supply pipe 151 by transmitting a control signal to the first fuel supply control unit 141.

In addition, the second fuel storage unit 144 has a constitution for storing a second fuel supplied to the manifold 120 inserted inside the solid oxide fuel cell 180. Here, the second fuel may be oxygen (H₂), but is not particularly limited thereto.

In addition, the present preferred embodiment may further include a second fuel supply pipe 153, such as a connecting unit connecting the second fuel storage unit 144 to the manifold 120.

In addition, the present invention may further include a second fuel supply control unit 143 for controlling the amount of the second fuel supplied from the second fuel storage unit 144 to the second fuel supply pipe 153. Here, the control unit 160 may control the amount of the second fuel supplied from the second fuel storage unit 144 to the second fuel supply pipe 153 by transmitting a control signal to the second fuel supply control unit 143.

In other words, the fuel is supplied by using manifold 120 inside the solid oxide fuel cell 180, and the fuel is supplied through the hole 111 formed in one surface of the heating furnace 110 outside the solid oxide fuel cell 180. The fuel supplied at this time may be hydrogen (H₂) and oxygen (O₂), respectively, but are not particularly limited thereto. Alternatively, oxygen (O₂) may be supplied inside the solid oxide fuel cell 180 and hydrogen (H₂) may be supplied outside the solid oxide fuel cell 180, due to the structure of the solid oxide fuel cell 180.

In the present preferred embodiment, the electronic load 140 is electrically connected to the solid oxide fuel cell 180 to measure current or voltage outputted from the solid oxide fuel cell 180.

Meanwhile, the electronic load 140 may apply a predetermined level of voltage or current to the solid oxide fuel cell 180.

In other words, in the present preferred embodiment, the control unit 160 controls the electronic load 140 to apply voltage or current to the solid oxide fuel cell 180, and also receives the current or voltage of the solid oxide fuel cell 180 measured by the electronic load 140.

In addition, the present preferred embodiment may further include a display unit 170 for displaying the current or voltage of the solid oxide fuel cell 180 measured by the electronic load 140. The control unit 160 receives the measured current or voltage from the electronic load 140, as described above, and may transmit it to the display unit 170.

Meanwhile, the system of the present preferred embodiment may further include a power compensation circuit for compensating a drop in voltage at terminals and circuit except for the solid oxide fuel cell 180, in order to prevent the lower limit of a measurable voltage to be raised due to a drop in voltage caused by current lines or an inner circuit of the electronic load 140, in a case where the output voltage is lower by 1V or less as compared with a case where high current is applied at the time of measurement of the solid oxide fuel cell 180.

In addition, the system 100 according to the present preferred embodiment may further include a third fuel storage unit 146 storing the third fuel supplied to the manifold 120, and further include a third fuel supply pipe 153, such as a connecting unit connecting between the manifold 120 and the third fuel storage unit 146.

In addition, the system 100 according to the present preferred embodiment may further include a third fuel supply control unit 145 for controlling the amount of third fuel supplied from the third fuel storage unit 146 to the third fuel supply pipe 153. Here, the third fuel may be nitrogen (N₂), but is not particularly limited thereto.

Here, the reason nitrogen (N₂) is used as the third fuel is because the temperature rise rate for performance evaluation and the cell reduction procedure are conducted in various manners.

Specifically, the reason is that the concentration of hydrogen (H₂) is controlled by mixing hydrogen (H₂) and nitrogen (N₂) at various ratios, and thus performance evaluation can be conducted under various conditions.

In addition, the reason is that the concentration of hydrogen (H₂) is dropped by supplying nitrogen (N₂) and thereby decreases the temperature, and nitrogen (N₂) is inputted at the time of an emergency such as cell destruction or the like and thereby stops the performance evaluation.

In addition, the system 100 according to the present preferred embodiment may further include a temperature sensor 112 for measuring an inner temperature of the heating furnace 110. Here, the temperature sensor 112 may be positioned on an inner wall of the heating furnace 110, but is not particularly limited thereto.

Although one temperature sensor 112 is shown in FIG. 1, but two or more temperature sensors 112 may be also provided.

The control unit 160 receives the inner temperature of the heating furnace 110 from the temperature sensor 112. If the inner temperature of the heating furnace 110 is lower than the target temperature, the control unit 160 increases the inner temperature of the heating furnace 110 by using heating lines (not shown) formed inside the heating furnace 110. If the inner temperature of the heating furnace 110 is higher than the target temperature, the control unit 160 stops heating through the heating lines (not shown) and then decrease the inner temperature of the heating furnace 110 by inputting nitrogen (N₂), as described above.

As such, according to the system 100 for measuring performance of a solid oxide fuel cell, one side of the solid oxide fuel cell 180, as a performance evaluation subject, to which fuel is inputted, is installed at the heating furnace 110 such that the side outwardly protrudes, thereby preventing two kinds of fuel from being mixed with each other in a high-temperature heating furnace even without performing a separate sealing work.

As such, the sealing work is unnecessary, thereby facilitating the work for performance evaluation and saving the time for performance evaluation.

### Second Preferred Embodiment 2

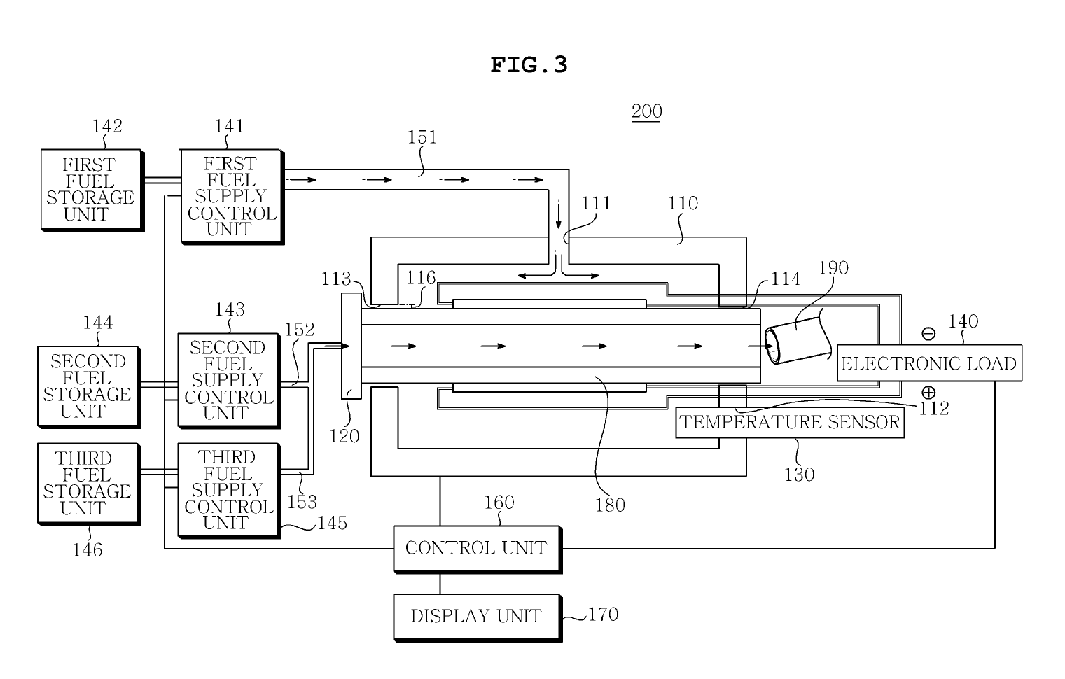

FIG. 3 is a block diagram showing a structure of a system for measuring performance of a solid oxide fuel cell according to another preferred embodiment of the present invention.

Here, descriptions of constitutions corresponding to the constitutions of the first preferred embodiment will be omitted, and the corresponding constitutions will be designated as identical reference numerals.

Referring to FIG. 3, a system 200 for measuring performance of a solid oxide fuel cell according to the present preferred embodiment include a heating furnace 110, a manifold 120, a first fuel storage unit 142, a second fuel storage unit 144, an electronic load 140, and a control unit 160, like the first preferred embodiment.

However, the present preferred embodiment is different from the first preferred embodiment in that the heating furnace 110 has a structure where both lateral surfaces of the solid oxide fuel cell 180 are exposed.

Specifically, as shown in FIG. 3, the heating furnace 110 according to the present preferred embodiment has a first opening part 113 and a second opening part 114 through which one lateral surface and the other lateral surface of the solid oxide fuel cell 180 are respectively exposed to the outside.

In other words, while the first preferred embodiment discloses that an opening part is formed at only one side of the heating furnace 110 and only one lateral surface of the solid oxide fuel cell 180 outwardly protrudes through the opening part, the present preferred embodiment discloses that opening parts are formed at both sides of the heating furnace 110 and both lateral surfaces of the solid oxide fuel cell 180 outwardly protrudes through the opening parts.

Meanwhile, the structure where both lateral surfaces of the solid oxide fuel cell are opened is shown in FIG. 3, but this is given for one example. The present preferred embodiment may be also applied to a solid oxide fuel cell 180 of which one lateral surface is opened and the other lateral surface is closed, like in the first preferred embodiment.

In addition, the present preferred embodiment is somewhat different from the first preferred embodiment in view of an arrangement structure of the manifold 120.

While the first preferred embodiment discloses that one end of the manifold 120 is deeply inserted inside the solid oxide fuel cell 180, the present preferred embodiment discloses that one end of the manifold 120 is connected to one of the lateral surfaces of the solid oxide fuel cell 180, as shown in FIG. 3.

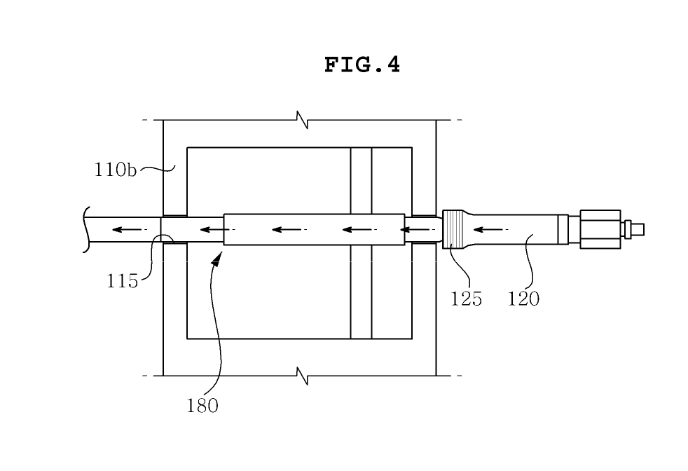

Here, the manifold 120 and one lateral surface of the solid oxide fuel cell 180 are coupled with each other by using a separate connecting member 125, as shown in FIG. 4, thereby preventing external impure gas from flowing into the manifold 120.

Here, a material for the connecting member 125 is not particularly limited, but it is preferable to use a material having elastic force that can seal between the manifold 120 and the solid oxide fuel cell 180 without any gaps, for the connecting member 125.

In addition, as shown in FIG. 3, the present preferred embodiment may further include an exhaust pipe 190 disposed adjacently to a lateral surface of the solid oxide fuel cell 180, which is not connected to the manifold 120, that is, the other lateral surface of the solid oxide fuel cell 180, through which the fuel inputted into the solid oxide fuel cell 180 through the manifold 120 is exhausted.

As set forth above, a sealing work for preventing mixing of different kinds of fuel is unnecessary, thereby decreasing the time for measurement work and reducing the working costs.

Further, according to the present invention, since the sealing work is unnecessary, a failure in measurement due to defective sealing does not occur, thereby improving the success rate in measurement

Although the preferred embodiments of the present invention have been disclosed for illustrative purposes, they are for specifically explaining the present invention and thus a system for measuring performance of a solid oxide fuel cell according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A system for measuring performance of a solid oxide fuel cell, comprising:
a heating furnace wrapping the solid oxide fuel cell, the heating furnace having a first opening part through which one lateral surface in a length direction of the solid oxide fuel cell outwardly protrudes and a fuel supply hole formed in one surface thereof;
a first fuel storage unit storing a first fuel supplied to the fuel supply hole;
a second fuel storage unit storing a second fuel supplied into the solid oxide fuel cell;
a first fuel supply control unit disposed between the first fuel storage unit and the fuel supply hole to control a supply amount of the first fuel;
a second fuel supply control unit disposed between the second fuel storage unit and the solid oxide fuel cell to control a supply amount of the second fuel;
an electronic load measuring current or voltage outputted from the solid oxide fuel cell; and
a control unit controlling the supply of fuel to the fuel supply hole and the solid oxide fuel cell from the first fuel storage unit and the second fuel storage unit by using the first fuel supply control unit and the second fuel supply control unit, and controlling the measurement of current or voltage outputted from the solid oxide fuel cell by using the electronic load.

2. The system as set forth in claim 1, further comprising a manifold having one end inserted into the solid oxide fuel cell through one lateral surface of the solid oxide fuel cell and the other end connected to the second fuel supply control unit, wherein one lateral surface of the solid oxide fuel cell is opened and the other lateral surface of the solid oxide fuel cell is closed.

3. The system as set forth in claim 2, further comprising a connecting unit connecting the second fuel supply control unit to the other end of the manifold.

4. The system as set forth in claim 2, further comprising:
a third fuel storage unit storing a third fuel supplied into the solid oxide fuel cell;
a third fuel supply control unit disposed between the third fuel storage unit and the solid oxide fuel cell to control a supply amount of the third fuel; and
a connecting unit connecting the third fuel supply control unit to the other end of the manifold.

5. The system as set forth in claim 4, wherein the third fuel is nitrogen (N₂).

6. The system as set forth in claim 1, further comprising a manifold having one end connected to one lateral surface of the solid oxide fuel cell and the other end connected to the second fuel supply control unit, wherein one lateral surface and the other lateral surface of the solid oxide fuel cell are opened, and the heating furnace further includes a second opening part through which the other lateral surface of the solid oxide fuel cell outwardly protrudes.

7. The system as set forth in claim 6, further comprising a connecting unit connecting the second fuel supply control unit to the other end of the manifold.

8. The system as set forth in claim 6, further comprising a connecting member coupling one lateral surface of the solid oxide fuel cell and one end of the manifold with each other.

9. The system as set forth in claim 6, further comprising an exhaust pipe disposed adjacently to the other lateral surface of the solid oxide fuel cell.

10. The system as set forth in claim 6, further comprising:
a third fuel storage unit storing a third fuel supplied into the solid oxide fuel cell;
a third fuel supply control unit disposed between the third fuel storage unit and the solid oxide fuel cell to control a supply amount of the third fuel; and
a connecting unit connecting the third fuel supply control unit to the other end of the manifold.

11. The system as set forth in claim 10, wherein the third fuel is nitrogen (N₂).

12. The system as set forth in claim 1, wherein the first fuel and the second fuel are oxygen (O₂) and hydrogen (H₂), respectively.

13. The system as set forth in claim 1, further comprising a display unit displaying current or voltage measured by the electronic load, wherein the control unit receives the current or voltage measured by the electronic load to transmit the received current or voltage to the display unit

14. The system as set forth in claim 1, further comprising a temperature sensor disposed on an inner wall of the heating furnace to measure an air temperature inside the heating furnace, wherein the control unit controls the driving of the heating furnace depending on the air temperature inside the heating furnace, which is measured by the temperature sensor.
